(19) United States
(12) Patent Application Publication
(10) Pub. No.: US 2018/0241085 A1
(43) Pub. Date: Aug. 23, 2018

(54) NONAQUEOUS ELECTROLYTIC SOLUTION AND NONAQUEOUS ELECTROLYTIC SOLUTION BATTERY USING THE SAME

(71) Applicant: TDK CORPORATION, Tokyo (JP)

(72) Inventor: Tomohiko HASEGAWA, Tokyo (JP)

(73) Assignee: TDK CORPORATION, Tokyo (JP)

(21) Appl. No.: 15/892,820

(22) Filed: Feb. 9, 2018

(30) Foreign Application Priority Data
Feb. 17, 2017 (JP) 2017-027732

(51) Int. Cl. H01M 10/0567; H01M 10/0525

(52) U.S. Cl. CPC H01M 10/0567; H01M 4/525; H01M 2300/0037; H01M 10/0525

(57) ABSTRACT

A nonaqueous electrolytic solution contains an additive selected from monofluorophosphate salts or difluorophosphate salts, and a Group 5 element. In the nonaqueous electrolytic solution, the Group 5 element may have a content in a range of 1×10⁻⁶ to 3×10⁻³ mol/L. The Group 5 element may be vanadium.

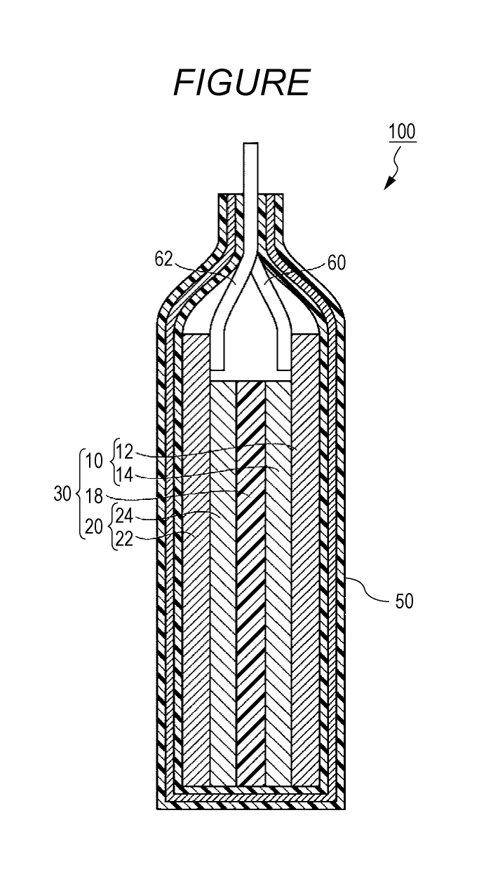

### CROSS-REFERENCE TO RELATED APPLICATION

This application claims priority from Japanese Patent Application No. 2017-027732 filed with the Japan Patent Office on Feb. 17, 2017, the entire content of which is hereby incorporated by reference.

### BACKGROUND

### 1. Technical Field

The present disclosure relates to a nonaqueous electrolytic solution and a nonaqueous electrolytic solution battery using the same.

### 2. Description of the Related Art

In recent years, lithium ion secondary batteries have been used as a main power supply for mobile communication devices and portable electronic devices. Lithium ion secondary batteries have high electromotive force and high energy density.

Electrolytic solutions for lithium ion secondary batteries include a lithium salt, which is an electrolyte, and a nonaqueous organic solvent. Requirements for nonaqueous organic solvents include a high dielectric constant for dissociating lithium salt, capability to express high ion conductivity over a wide temperature region, and stability in the battery. It is difficult to achieve those requirements with a single solvent. Accordingly, a high-boiling point solvent, such as represented by propylene carbonate and ethylene carbonate, and a low-boiling point solvent such as dimethyl carbonate and diethyl carbonate are typically used in combination.

A number of attempts have also been made to improve various battery characteristics, such as initial capacity, rate performance, a cycle characteristic, a high-temperature storage characteristic, a continuous charge characteristic, a self-discharge characteristic, and an overcharge prevention characteristic, by adding additives to the electrolytic solution. For example, as a method for suppressing self-discharge at elevated temperatures, it has been reported to add fluorophosphate lithium and the like to the electrolytic solution (JP-A-11-67270).

### SUMMARY

A nonaqueous electrolytic solution includes an additive selected from monofluorophosphate salts or difluorophosphate salts, and a Group 5 element.

### BRIEF DESCRIPTION OF THE DRAWINGS

FIGURE is a schematic cross sectional view of a lithium ion secondary battery according to the present embodiment.

### DESCRIPTION OF THE EMBODIMENTS

In the following detailed description, for purpose of explanation, numerous specific details are set forth in order to provide a thorough understanding of the disclosed embodiments. It will be apparent, however, that one or more embodiments may be practiced without these specific details. In other instances, well-known structures and devices are schematically shown in order to simplify the drawing.

The methods according to typical techniques have been unable to satisfy various characteristics. In particular, with respect to a laminate battery, suppression of the generation of gas during a high-temperature storage test is being required.

An object of the present disclosure is to provide a nonaqueous electrolytic solution with which the generation of gas during a high-temperature storage test can be suppressed, and a nonaqueous electrolytic solution battery using the same.

A nonaqueous electrolytic solution according to an embodiment of the present disclosure (the present nonaqueous electrolytic solution) includes an additive selected from monofluorophosphate salts or difluorophosphate salts, and a Group 5 element.

In this way, a synergistic effect can be obtained by the inclusion of the additive and Group 5 element in the electrolytic solution, whereby the generation of gas during a high-temperature storage test can be suppressed.

While the details of the cause of the expression of the synergistic effect are not clear, the cause is believed to be the following. Group 5 elements can take a variety of oxidation numbers. Accordingly, when a Group 5 element is taken into a coating film formed by the additive that has been dissolved, the Group 5 element serves as cross-linking points. As a result, it becomes possible to form a coating film having a three-dimensionally strong network. The stable coating film suppresses the reaction of the electrodes and the electrolytic solution, enabling the suppression of the generation of gas during a high-temperature storage test.

Preferably, in the present nonaqueous electrolytic solution, the Group 5 element has a content in a range of 1−10⁻⁶ to 3×10⁻³ mol/L.

The range is a preferable range of the added amount of Group 5 element. Accordingly, the generation of gas during a high-temperature storage test can be further suppressed.

Preferably, in the present nonaqueous electrolytic solution, the Group 5 element is vanadium.

Vanadium is more preferable as the Group 5 element added to the present nonaqueous electrolytic solution. Use of vanadium as the Group 5 element makes it possible to further suppress the generation of gas during a high-temperature storage test.

Preferably, in the present nonaqueous electrolytic solution, the additive has a content in a range of 1×10⁻³ to 3×10⁻¹ mol/L.

The range is a preferable range of the added amount of additive. Accordingly, the generation of gas during a high-temperature storage test can be further suppressed.

Preferably, in the present nonaqueous electrolytic solution, the additive is difluorophosphate lithium.

Difluorophosphate lithium is more preferable as the additive added to the present nonaqueous electrolytic solution. Use of difluorophosphate lithium as the additive makes it possible to further suppress the generation of gas during a high-temperature storage test.

According to the present nonaqueous electrolytic solution, the generation of gas during a high-temperature storage test can be suppressed, and a nonaqueous electrolytic solution battery using the present nonaqueous electrolytic solution can also be provided.

In the following, a preferred embodiment of the present disclosure will be described with reference to the drawing figures. However, the technology of the present disclosure is not limited to the following embodiment. The constituent elements described below may include elements that may easily occur to a person skilled in the art, and elements that are substantially identical to the disclosed constituent elements. The constituent elements described below may be combined as appropriate.

### Lithium Ion Secondary Battery

As illustrated in the figure, a lithium ion secondary battery 100 according to the present embodiment includes a stacked body 30, a nonaqueous solution containing lithium ions, a case 50 in which the above elements are contained in sealed state, a lead 62, and a lead 60. The stacked body 30 includes a plate-shaped negative electrode 20 and a plate-shaped positive electrode 10 facing each other, and a plate-shaped separator 18 disposed adjacent to and between the negative electrode 20 and the positive electrode 10. One end of the lead 62 is electrically connected to the negative electrode 20. The other end of the lead 62 protrudes out of the case. One end of the lead 60 is electrically connected to the positive electrode 10. The other end of the lead 60 protrudes out of the case.

The positive electrode 10 includes a positive electrode current collector 12, and a positive electrode active material layer 14 formed on the positive electrode current collector 12. The negative electrode 20 includes a negative electrode current collector 22, and a negative electrode active material layer 24 formed on the negative electrode current collector 22. The separator 18 is positioned between the negative electrode active material layer 24 and the positive electrode active material layer 14. Positive electrode

### Positive Electrode Current Collector

The positive electrode current collector 12 may be formed from an electrically conductive plate material. The positive electrode current collector 12 may include a metal thin plate (metal foil) of aluminum, aluminum alloy, or stainless steel and the like, for example.

### Positive Electrode Active Material Layer

The positive electrode active material layer 14 mainly includes a positive electrode active material, a positive electrode binder, a positive electrode conductive auxiliary agent, and a positive electrode additive.

### Positive Electrode Active Material

The positive electrode active material is not particularly limited as long as the material is capable of causing reversible occlusion and release of lithium ions or deintercalation and insertion (intercalation) of lithium ions, or causing reversible doping and undoping of counter anions (such as PF₆⁻) of the lithium ions. A known electrode active material may be used. Examples of the positive electrode active material include mixed metal oxides of lithium cobaltate (LiCoO₂), lithium nickelate (LiNiO₂), lithium manganese spinel (LiMn₂O₄), and compounds expressed by the chemical formula LiNiₓCo_{y}Mn_{z}MaO₂ (where x+y+z+a=1, 0≤x≤1, 0≤y≤1, 0≤z≤1, 0≤a≤1, and M is one or more elements selected from Al, Mg, Nb, Ti, Cu, Zn, and Cr). The mixed metal oxides include a lithium vanadium compound Liₐ(M)_{b}(PO₄)_{c} (where M =VO or V, and 0.9≤a≤3.3, 0.9≤b≤2.2, 0.9≤c≤3.3), olivine LiMPO₄ (where M is one or more elements selected from Co, Ni, Mn, Fe, Mg, Nb, Ti, Al, and Zr, or VO), lithium titanate (Li₄Ti₅O₁₂), and LiNiₓCo_{y}Al_{z}O₂ (0.9<x+y+z<1.1).

### Positive Electrode Binder

The positive electrode binder binds the positive electrode active material, and also binds the positive electrode active material layer 14 and the positive electrode current collector 12. The binder may be any binder capable of achieving the binding described above. The binder may include, for example, fluorine resins such as polyvinylidene fluoride (PVDF) and polytetrafluoroethylene (PTFE); cellulose; styrene-butadiene rubber; ethylene-propylene rubber; polyimide resin; and polyamide-imide resin. The binder may include electron-conductive electrically conductive polymers and ion-conductive electrically conductive polymers. Examples of the electron-conductive electrically conductive polymers include polyacetylene, polythiophene, and polyaniline. Examples of the ion-conductive electrically conductive polymers include polyether-based polymer compounds, such as polyethylene oxide or polypropylene oxide, compounded with a lithium salt such as LiClO₄, LiBF₄, or LiPF₆.

The content of the binder in the positive electrode active material layer 14 is not particularly limited. When the binder is added into the positive electrode active material layer 14, the content of the binder in the positive electrode active material layer 14 is preferably 0.5 to 5 parts by mass with respect to the mass of the positive electrode active material.

### Positive Electrode Conductive Auxiliary Agent

The positive electrode conductive auxiliary agent is not particularly limited, and known conductive auxiliary agents may be used as long as the electrical conductivity of the positive electrode active material layer 14 can be improved. Examples of the positive electrode conductive auxiliary agent include carbon-based materials such as graphite and carbon black; metal fine powder of copper, nickel, stainless steel, iron and the like; and electrically conductive oxides such as ITO. Negative electrode

### Negative Electrode Current Collector

The negative electrode current collector 22 may include an electrically conductive plate material. For example, as the negative electrode current collector 22, a metal thin plate (metal foil) of copper may be used.

### Negative Electrode Active Material Layer

The negative electrode active material layer 24 mainly includes a negative electrode active material, a negative electrode binder, and a negative electrode conductive auxiliary agent.

### Negative Electrode Active Material

The negative electrode active material is not particularly limited and a known electrode active material may be used as long as the material is capable of reversibly causing occlusion and release of lithium ions or deintercalation and intercalation of lithium ions. Examples of the negative electrode active material include carbon-based materials such as graphite and hard carbon; silicon-based materials such as silicon oxide (SiOₓ) and metallic silicon (Si); metallic oxides such as lithium titanate (LTO); and metallic materials such as lithium, tin, and zinc.

When a metallic material is not used as the negative electrode active material, the negative electrode active material layer 24 may further include a negative electrode binder and a negative electrode conductive auxiliary agent.

### Negative Electrode Binder

The negative electrode binder is not particularly limited. As the negative electrode binder, an electrode binder similar to the above-described positive electrode binder may be used.

### Negative Electrode Conductive Auxiliary Agent

The negative electrode conductive auxiliary agent is not particularly limited. As the negative electrode conductive auxiliary agent, a conductive auxiliary agent similar to the above-described positive electrode conductive auxiliary agent may be used.

### Nonaqueous Electrolytic Solution

The nonaqueous electrolytic solution according to the present embodiment includes an additive selected from monofluorophosphate salts or difluorophosphate salts, and a Group 5 element.

In this way, a synergistic effect can be obtained by the inclusion of the additive and Group 5 element in the electrolytic solution, whereby the generation of gas during a high-temperature storage test can be suppressed.

While the details of the cause of the expression of the synergistic effect are not clear, the cause is believed to be the following. Group 5 elements can take a variety of oxidation numbers. Accordingly, when a Group 5 element is taken into a coating film formed by the additive that has been dissolved, the Group 5 element serves as cross-linking points. As a result, it becomes possible to form a coating film having a three-dimensionally strong network. The stable coating film suppresses the reaction of the electrodes and the electrolytic solution, enabling the suppression of the generation of gas during a high-temperature storage test.

Preferably, in the nonaqueous electrolytic solution according to the present embodiment, the Group 5 element has a content in a range of 1×10⁻⁶ to 3×10⁻³ mol/L.

The range is a preferable range of the added amount of the Group 5 element. Accordingly, the generation of gas during a high-temperature storage test can be further suppressed.

Preferably, in the nonaqueous electrolytic solution according to the present embodiment, the Group 5 element is vanadium.

Vanadium is more preferable as the Group 5 element added to the nonaqueous electrolytic solution. Use of vanadium as the Group 5 element makes it possible to further suppress the generation of gas during a high-temperature storage test.

Preferably, the additive in the nonaqueous electrolytic solution according to the present embodiment has a content in a range of 1×10⁻³ to 3×10⁻¹ mol/L.

The range is a preferable range of the added amount of the additive. Accordingly, the generation of gas during a high-temperature storage test can be further suppressed.

Preferably, in the nonaqueous electrolytic solution according to the present embodiment, the additive is difluorophosphate lithium.

Difluorophosphate lithium is more preferable as the additive added to the nonaqueous electrolytic solution. Use of difluorophosphate lithium as the additive makes it possible to further suppress the generation of gas during a high-temperature storage test.

### Solvent

The electrolyte solvent may be a solvent generally used in a lithium ion secondary battery and is not particularly limited. The electrolyte solvent may include the following solvents mixed at any desired ratio: an annular carbonate compound such as ethylene carbonate (EC) and propylene carbonate (PC); a chain carbonate compound such as diethyl carbonate (DEC) and ethyl methyl carbonate (EMC); an annular ester compound such as γ-butyrolactone; and a chain ester compound such as propyl propionate, ethyl propionate, and ethyl acetate.

### Electrolyte

The electrolyte may be a lithium salt used as the electrolyte for lithium ion secondary batteries and is not particularly limited. Examples of the electrolyte include inorganic acid anion salts such as LiPF₆, LiBF₄, and lithium bis(oxalato)borate; and organic acid anion salts such as LiCF₃SO₃, (CF₃SO₂)₂NLi, and (FSO₂)₂NLi.

A preferred embodiment of the present disclosure has been described; however, the technology of the present disclosure is not limited to the embodiment.

### EXAMPLES

In the following, the technology of the present disclosure will be described more concretely with reference to examples and comparative examples. The technology of the present disclosure, however, is not limited to the following examples.

### Example 1

### Fabrication of Positive Electrode

A slurry for forming the positive electrode active material layer was prepared by dispersing 85 parts by mass of Li(Ni_{0.85}Co_{0.10}Al_{0.05})O₂, 5 parts by mass of carbon black, and 10 parts by mass of PVDF in N-methyl-2-pyrrolidone (NMP). The slurry was applied to a surface of an aluminum metal foil with a thickness of 20 μm in such a way that the applied amount of the positive electrode active material was 9.0 mg/cm². The aluminum metal foil with the slurry applied thereon was dried at 100° C. In this way, the positive electrode active material layer was formed. Thereafter, the positive electrode active material layer was pressed and molded using a roller press, whereby the positive electrode was fabricated.

### Fabrication of Negative Electrode

A slurry for forming the negative electrode active material layer was prepared by dispersing 90 parts by mass of natural graphite, 5 parts by mass of carbon black, and 5 parts by mass of PVDF in N-methyl-2-pyrrolidone (NMP). The slurry was applied to a surface of a copper foil with a thickness of 20 μm in such a way that the coated amount of the negative electrode active material was 6.0 mg/cm². The copper foil with the slurry applied thereon was dried at 100° C. In this way, the negative electrode active material layer was formed. Thereafter, the negative electrode active material layer was pressed and molded using a roller press, whereby the negative electrode was fabricated.

### Fabrication of Electrolytic Solution

EC and DEC were mixed to a volume ratio of EC/DEC=3/7. Into the mixture of EC and DEC, LiPF₆ was dissolved such that the concentration of LiPF₆ became 1 mol/L. Thereafter, into the resultant solution, vanadium pentafluoride (VF₅) as Group 5 element was added in such a way that the concentration of VF₅ became 1.0×10⁻⁶ mol/L. Further, difluorophosphate lithium (LiPO₂F₂) was added as an additive to the solution in such a way that the concentration of LiPO₂F₂ became 1.0×10⁻² mol/L. In this way, the electrolytic solution was fabricated.

### Fabrication of Lithium Ion Secondary Battery for Evaluation

The positive electrode and the negative electrode fabricated as described above were laid on each other with a separator of polyethylene microporous film interposed therebetween, and put in an aluminum laminate pack. Into the aluminum laminate pack, the electrolyte fabricated as described above was injected. Thereafter, the aluminum laminate pack was vacuum-sealed, whereby the lithium ion secondary battery for evaluation was fabricated.

### Measurement of the Amount of Generation of Gas During a High-Temperature Storage Test

The lithium ion secondary battery for evaluation fabricated as described above was charged using a secondary battery charge/discharge test device (manufactured by Hokuto Denko Corp.) by constant current charging at a charge rate of 0.5 C until the battery voltage became 4.2 V. The current value at the charge rate of 0.5 C means a current value such that when constant current charge is performed at 25° C., the charging will end in two hours. At the end of the charging, the aluminum laminate pack of the battery was partly cut to release gas from the aluminum laminate pack. Thereafter the aluminum laminate pack was again vacuum-sealed. The volume of the battery was measured by the Archimedes method to determine a battery volume V₁ before the high-temperature storage test.

The battery whose battery volume V₁ was determined was allowed to stand in a constant-temperature bath (manufactured by Espec Corp.) with the temperature set at 85° C. for four hours. After the four hours, the battery was removed and allowed to dissipate heat at room temperature for 15 minutes. Thereafter, the battery volume was again measured by the Archimedes method to determine a battery volume V₂ after the high-temperature storage test.

From the volumes V₁ and V₂ determined before and after the high-temperature storage test, the amount V of generation of gas during the high-temperature storage test was determined according to expression (3). The obtained results are shown in Table 1.

V=V₂−V₁ (3)

### Examples 2 to 6

The lithium ion secondary batteries for evaluation in examples 2 to 6 were fabricated in the same way as in example 1, with the exception that the added amount of Group 5 element used during the fabrication of the electrolytic solution was changed as shown in Table 1.

### Examples 7 to 13

The lithium ion secondary batteries for evaluation in examples 7 to 13 were fabricated in the same way as in example 1, with the exception that the additive used and the added amount thereof during the fabrication of the electrolytic solution were changed as shown in Table 1, wherein Li₂PO₃F is lithium monofluorophosphate.

### Examples 14 to 19

The lithium ion secondary batteries for evaluation in examples 14 to 19 were fabricated in the same way as in example 1, with the exception that the Group 5 element used during the fabrication of the electrolytic solution was changed as shown in Table 1, wherein NbF₅ is niobium pentafluoride, and TaF₅ is tantalum pentafluoride.

### Comparative Example 1

As shown in Table 1, the lithium ion secondary battery for evaluation in comparative example 1 was fabricated in the same way as in example 1, with the exception that no Group 5 element was added during the fabrication of the electrolytic solution.

### Comparative Example 2

As shown in Table 1, the lithium ion secondary battery for evaluation in comparative example 2 was fabricated in the same way as in example 1, with the exception that no additive was added during the fabrication of the electrolytic solution.

With respect to the lithium ion secondary batteries for evaluation fabricated according to examples 2 to 19 and comparative examples 1 and 2, the measurement of the amount of generation of gas during the high-temperature storage test was performed as in example 1. The measurement results are shown in Table 1.

In examples 1 to 19, compared with comparative example 1 in which no Group 5 element was added and comparative example 2 in which no additive was added, the amount of generation of gas during the high-temperature storage test was suppressed. This clearly indicates that a synergistic effect can be obtained by adding Group 5 element and additive to the electrolytic solution. From the results of examples 1 to 6 and examples 7 to 10, it has been confirmed that the amount of generation of gas during the high-temperature storage test can be suppressed more by optimizing the added amounts of Group 5 element and the additive. In addition, from the results of examples 3, 7, and 8, it has been confirmed that the amount of generation of gas during the high-temperature storage test can be further suppressed by optimizing the ratios of the added amounts of Group 5 element and the additive.

From the results of examples 11 to 13, it has been confirmed that the amount of generation of gas during the high-temperature storage test can be even more suppressed with the use of LiPO₂F₂ as the additive.

From the results of examples 14 to 19, it has been confirmed that the amount of generation of gas during the high-temperature storage test can be suppressed even when Nb(NbF₅) or Ta(TaF₅) is used as Group 5 element.

TABLE 1

| | | Added amount of | | Added amount pf | Amount of generation of gas |
|---|---|---|---|---|---|
| | | Group 5 element | | additive | during high-temperature |
| | Group 5 element compound | [mol/L] | Additive | [mol/L] | storage test [mL] |
| Example 1 | VF₅ | 1.0 × 10⁻⁶ | LiPO₂F₂ | 1.0 × 10⁻² | 0.33 |
| Example 2 | VF₅ | 1.0 × 10⁻⁵ | LiPO₂F₂ | 1.0 × 10⁻² | 0.34 |
| Example 3 | VF₅ | 1.0 × 10⁻⁴ | LiPO₂F₂ | 1.0 × 10⁻² | 0.25 |
| Example 4 | VF₅ | 3.0 × 10⁻³ | LiPO₂F₂ | 1.0 × 10⁻² | 0.35 |
| Example 5 | VF₅ | 3.1 × 10⁻³ | LiPO₂F₂ | 1.0 × 10⁻² | 0.67 |
| Example 6 | VF₅ | 5.0 × 10⁻³ | LiPO₂F₂ | 1.0 × 10⁻² | 0.64 |
| Example 7 | VF₅ | 1.0 × 10⁻⁴ | LiPO₂F₂ | 1.0 × 10⁻³ | 0.36 |
| Example 8 | VF₅ | 1.0 × 10⁻⁴ | LiPO₂F₂ | 3.0 × 10⁻¹ | 0.39 |
| Example 9 | VF₅ | 1.0 × 10⁻⁴ | LiPO₂F₂ | 3.1 × 10⁻¹ | 0.70 |
| Example 10 | VF₅ | 1.0 × 10⁻⁴ | LiPO₂F₂ | 4.1 × 10⁻¹ | 0.69 |
| Example 11 | VF₅ | 1.0 × 10⁻⁵ | Li₂PO₃F | 1.0 × 10⁻² | 0.42 |
| Example 12 | VF₅ | 1.0 × 10⁻⁴ | Li₂PO₃F | 1.0 × 10⁻² | 0.38 |
| Example 13 | VF₅ | 3.0 × 10⁻³ | Li₂PO₃F | 1.0 × 10⁻² | 0.44 |
| Example 14 | NbF5 | 1.0 × 10⁻⁵ | LiPO₂F₂ | 1.0 × 10⁻² | 0.38 |
| Example 15 | NbF5 | 1.0 × 10⁻⁴ | LiPO₂F₂ | 1.0 × 10⁻² | 0.32 |
| Example 16 | NbF5 | 3.0 × 10⁻³ | LiPO₂F₂ | 1.0 × 10⁻² | 0.37 |
| Example 17 | TaF5 | 1.0 × 10⁻⁵ | LiPO₂F₂ | 1.0 × 10⁻² | 0.39 |
| Example 18 | TaF5 | 1.0 × 10⁻⁴ | LiPO₂F₂ | 1.0 × 10⁻² | 0.35 |
| Example 19 | TaF5 | 3.0 × 10⁻³ | LiPO₂F₂ | 1.0 × 10⁻² | 0.40 |
| Comparative Example 1 | — | — | LiPO₂F₂ | 1.0 × 10⁻² | 0.97 |
| Comparative Example 2 | VF5 | 1.0 × 10⁻⁴ | — | — | 0.99 |

As described above, the technology of the present disclosure provides a nonaqueous electrolytic solution with which the generation of gas after a high-temperature storage test can be suppressed, and a nonaqueous electrolytic solution battery using the same.

The foregoing detailed description has been presented for the purposes of illustration and description. Many modifications and variations are possible in light of the above teaching. It is not intended to be exhaustive or to limit the subject matter described herein to the precise form disclosed. Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims appended hereto.

What is claimed is:

1. A nonaqueous electrolytic solution comprising:
an additive selected from monofluorophosphate salts or difluorophosphate salts; and
a Group 5 element.

2. The nonaqueous electrolytic solution according to claim 1, wherein the Group 5 element in the nonaqueous electrolytic solution has a content in a range of 1×10⁻⁶ to 3×10⁻³ mol/L.

3. The nonaqueous electrolytic solution according to claim 1, wherein the Group 5 element is vanadium.

4. The nonaqueous electrolytic solution according to claim 2, wherein the Group 5 element is vanadium.

5. The nonaqueous electrolytic solution according to claim 1, wherein the additive in the nonaqueous electrolytic solution has a content in a range of 1×10^{-3 to} 3×10⁻¹ mol/L.

6. The nonaqueous electrolytic solution according to claim 2, wherein the additive in the nonaqueous electrolytic solution has a content in a range of 1×10⁻³ to 3×10⁻¹ mol/L.

7. The nonaqueous electrolytic solution according to claim 3, wherein the additive in the nonaqueous electrolytic solution has a content in a range of 1×10⁻³ to 3×10⁻¹ mol/L.

8. The nonaqueous electrolytic solution according to claim 4, wherein the additive in the nonaqueous electrolytic solution has a content in a range of 1×10⁻³ to 3×10⁻¹ mol/L.

9. The nonaqueous electrolytic solution according to claim 1, wherein the additive is difluorophosphate lithium.

10. The nonaqueous electrolytic solution according to claim 2, wherein the additive is difluorophosphate lithium.

11. The nonaqueous electrolytic solution according to claim 3, wherein the additive is difluorophosphate lithium.

12. The nonaqueous electrolytic solution according to claim 4, wherein the additive is difluorophosphate lithium.

13. The nonaqueous electrolytic solution according to claim 5, wherein the additive is difluorophosphate lithium.

14. The nonaqueous electrolytic solution according to claim 6, wherein the additive is difluorophosphate lithium.

15. The nonaqueous electrolytic solution according to claim 7, wherein the additive is difluorophosphate lithium.

16. The nonaqueous electrolytic solution according to claim 8, wherein the additive is difluorophosphate lithium.

17. A nonaqueous electrolytic solution battery comprising the nonaqueous electrolytic solution according to claim 1.
